(19) United States
(12) Patent Application Publication
(10) Pub. No.: US 2018/0369668 A1
(43) Pub. Date: Dec. 27, 2018

(54) ARTICLE OF SPORTING EQUIPMENT WITH HEATED HAND GRIP

(71) Applicant: Woodward T. King, Atlanta, GA (US)

(72) Inventor: Woodward T. King, Atlanta, GA (US)

(21) Appl. No.: 16/018,624

(22) Filed: Jun. 26, 2018

Related U.S. Application Data
(60) Provisional application No. 62/524,736, filed on Jun. 26, 2017.

(51) Int. Cl. A63B 60/06; H05B 3/34

(52) U.S. Cl. CPC A63B 60/06; A63B 2225/64; H05B 2203/002; H05B 3/34

(57) ABSTRACT

An example embodiment provides an article of sporting equipment having a heated hand grip. The article of sporting equipment comprises a shaft; a heated grip tape about at least a portion of a grip portion of the shaft; an overgrip disposed about the heated grip tape and the grip portion of the shaft; and a power source receiver configured to place a power source in electrical communication with the one of the heated grip tape or heated grip sleeve. In an example embodiment, the shaft is at least partially hollow defining, at least in part, a grip cavity and a stopper is disposed adjacent a second end of the grip cavity. The stopper is made of a thermally insulating material configured to insulate against thermal energy generated by a chemical heating packet inserted within the grip cavity from flowing down the shaft away from the grip cavity.

### CROSS REFERENCE TO RELATED APPLICATIONS

This application claims priority to U.S. Application No. 62/524,736, filed Jun. 26, 2017, the content of which is hereby incorporated herein in its entirety.

### BACKGROUND

When playing a round of golf on a chilly day, gripping the cold hand grip of the golf club may be unpleasant. For example, it is not advisable to wear thick gloves when swinging a golf club, as your swing may be negatively affected. Therefore, playing a round of golf on a chilly day may be more pleasant if the hand grips of the golf clubs are warm to the touch. However, previous techniques for heating a golf club hand grip tend to be inefficient. For example, previous techniques for heating a golf club hand grip tend to result in heat being lost from the grip area and down the shaft of the golf club.

Therefore, there is a need for golf clubs, and other articles of sporting equipment, with heated hand grips, wherein the hand grip is efficiently heated.

### BRIEF SUMMARY

Example embodiments provide an article of sporting equipment having a heated hand grip. Some non-limiting examples of articles of sporting equipment that are provided by various embodiments comprise golf clubs, tennis rackets, badminton rackets, racquetball rackets, ski poles, hockey sticks, field hockey sticks, lacrosse sticks, croquet mallets, baseball bats, cricket bats, and/or the like. For example, a stopper that is thermally insulating may be positioned at an end of a grip cavity within the hand grip to prevent, at least in part, the flow of thermal energy from the hand grip to the shaft and/or other portions of the article of sporting equipment.

According to a first aspect of the present invention, an article of sporting equipment having a heated hand grip is provided. In an example embodiment, the article of sporting equipment comprises a shaft, wherein (a) the shaft is at least partially hollow, (b) the interior of the shaft defines a grip cavity, and (c) a grip cap is disposed at a first end of the shaft to enclose the grip cavity. In an example embodiment, the article of sporting equipment further comprises a hand grip disposed about a portion of the shaft, wherein (a) a first end of the hand grip is disposed at a first end of the shaft and (b) the hand grip extends along the shaft from the first end to a second end of the hand grip at an intermediate point of the shaft. In an example embodiment, the article of sporting equipment further comprises a stopper disposed at the second end of the hand grip and within the grip cavity. The stopper is made of a thermally insulating material configured to prevent, at least in part, thermal energy emitted by a chemical heating packet inserted within the grip cavity from flowing down the shaft.

According to another aspect of the present invention, an article of sporting equipment having a heated hand grip is provided. In an example embodiment, the article of sporting equipment comprises a shaft and a hand grip disposed about a portion of the shaft. A first end of the hand grip is disposed at a first end of the shaft and the hand grip extends along the shaft from the first end to a second end of the hand grip at an intermediate point of the shaft. In an example embodiment, the article of sporting equipment comprises one of a heated grip tape or heated grip sleeve about at least a portion of the hand grip; and a power source receiver configured to place a power source in electrical communication with the one of the heated grip tape or heated grip sleeve.

According to yet another aspect of the present invention, a heated hand grip for an article of sporting equipment is provided. In an example embodiment, the heated hand grip comprises a flexible electrical circuit comprising one or more resistive heating elements disposed under or within a grip material. The grip material comprises one of a tape or a sleeve configured to secure the flexible electrical circuit to the hand grip of an article of sporting equipment. The heated hand grip further comprises a power source receiver in electrical communication with the flexible electrical circuit.

According to still other aspects of the present invention, various methods are provided for preparing an article of sporting equipment having a heated hand grip for use and using an article of sporting equipment having a heated hand grip.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram of an example golf club with a heated hand grip, in accordance with an example embodiment of at least one embodiment;

FIG. 2 provides a partial cross-section of the example golf club illustrated in FIG. 1;

FIGS. 3A and 3B each provide a cross-section of a grip cap and packet retaining assembly, in accordance with example embodiments;

FIG. 4 provides a flowchart illustrating an example technique of preparing an article of sporting equipment having a heated hand grip for use, in accordance with an example embodiment;

FIG. 5 provides a cross-section of a golf club grip, in accordance with an example embodiment; and

FIG. 6 provides a flowchart illustrating an example technique of preparing and using an article of sporting equipment having a heated hand grip, in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. As used herein, the term approximately refers to within applicable manufacturing and/or engineering tolerances.

Example embodiments provide an article of sporting equipment having a heated hand grip. In an example embodiment, a thermally insulated plug, stopper, and/or the like prevents, at least in part, the flow of thermal energy from the hand grip of the article of sporting equipment to the remainder of the article of sporting equipment. Some non-limiting examples of articles of sporting equipment that are provided by various embodiments comprise golf clubs, tennis rackets, badminton rackets, racquetball rackets, ski poles, hockey sticks, field hockey sticks, lacrosse sticks, croquet mallets, baseball bats, cricket bats, paddle ball paddles, fishing poles, and/or the like such as bicycle handlebars. Various embodiments of the present invention will now be described using a golf club as an example article of sporting equipment. However, it should be understood that the teachings provided herein may be applied to other articles of sporting equipment.

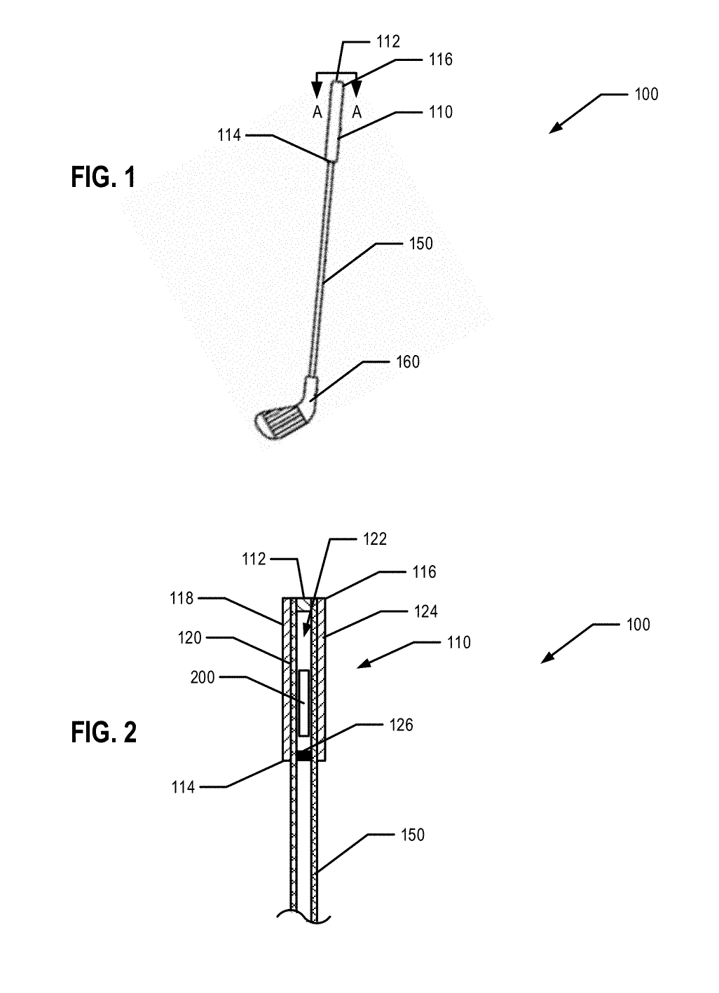

FIG. 1 provides a schematic diagram of an example golf club 100. FIG. 2 provides a partial cross-section of the golf club 100. For example, the golf club 100 comprises a hand grip 110, a shaft 150, and a club head 160. The shaft 150 may extend from the first end 116 of the hand grip 116, through the second end 114 of the hand grip, and to the club head 160. The shaft 150 may be formed from steel or graphite or other suitable golf club materials provided there is a grip cavity provided under the hand grip 110 as discussed below. In an example embodiment, the grip is disposed about a portion of the shaft 150 extending from the first end 116 to the second end 114 of the hand grip 110. For example, the second end 114 of the hand grip 110 is an intermediate point along the shaft 150. The first end 116 of the hand grip 110 is also a first end of the shaft 150. In an example embodiment, the shaft 150 is at least partially hollow. For example, the shaft 150 is a rigid tube, in one example embodiment. The club head 160 may be secured to the shaft 150 at an end of the shaft opposite the first end 116. A grip cap 112 may be disposed at the first end 116 of the hand grip 110.

In an example embodiment, the grip cap 112 may be selectively removable from the first end of the hand grip 110. For example, the grip cap 112, may be selectively removably secured to the first end of the hand grip 110 by a friction fit, a threaded interface, a tab and notch assembly, and/or other selectively removable securing mechanism. For example, in an example embodiment, the grip cap 112 is secured to the first end of the hand grip via a friction fit by engaging the interior diameter of the grip cavity 122. For example, the grip cap 112 may be secured to the first end 116 of the hand grip 110 via a friction fit by engaging the interior surface 120 of the shaft 150. For example, the grip cap 112 may comprise a portion that is inserted into an opening at the first end 116 of the shaft 150 such that an inner surface 120 of the shaft engages the outer surface of the inserted portion to retain the inserted portion within the opening. In an example embodiment, the grip cap 112 is configured to be selectively expanded when the grip cap is positioned within the grip cavity 122 adjacent the first end 116 so as to engage the inner surface 120 of the shaft 150. In another example embodiment, a portion of the grip cap 112 comprises threads and the hand grip 110 comprises complimentary threads such that the grip cap may be secured to the hand grip by mating the grip cap threads and the hand grip threads. In another example embodiment, the grip cap 112 or the hand grip 110 comprises one or more tabs configured to engage corresponding notches on the other of the grip cap or the hand grip to secure the grip cap to the hand grip.

The hand grip 110 may be made of any material that provides a good gripping surface and that is at least partially thermally conductive. Conventional elastomeric grips are an example. A grip tape layer may be applied to the club shaft in advance of installation of the grip. The hand grip 110 comprises an outer surface 118 and an inner surface 120. The outer surface 118 is configured to be gripped by a user of the golf club 100. The inner surface 120 is an inner surface of the shaft 150, in an example embodiment.

In an example embodiment, the inner surface 120, the first end 116, and the second end 114 define a grip cavity 122 within the hand grip 110. For example, the grip cavity 122 may be an empty space that extends along the axis of the hand grip 110 and/or shaft 150. An end of the grip cavity 122 nearest the second end 114 of the hand grip 110 may be closed off, sealed, and/or the like by a stopper 126. For example, a stopper 126 may be disposed within the grip cavity 122 adjacent the second end 114. For example, a stopper 126 may be wedged into a position within the grip cavity 122 and adjacent the second end 114 of the hand grip 110. In an example embodiment, the stopper 126 is made of a thermally insulating material. For example, the stopper 126 may be sponge, expandable polyurethane, rubber, and/or the like. In an example embodiment, the stopper 126 is made of a material that has a lower heat transfer coefficient than the material of the hand grip 110 and/or the material of the shaft 150. In an example embodiment, the stopper 126 may be tapered or slightly tapered. For example, a cross-section taken along a diameter of the stopper 126 may be generally trapezoidal. For example, the stopper 126 may comprise a first surface that generally defines a first plane and a second surface that generally defines a second plane. The first plane is parallel to the second plane. The first surface and the second surface may be generally circular, in an example embodiment. The first surface defines a first diameter and the second surface defines a second diameter. The first diameter may be smaller than the second diameter, in an example embodiment. For example, the first diameter may be one-tenth to ten millimeters smaller than the second diameter. The stopper 126 may be positioned such that the first surface is facing along the shaft 150 toward the club head 160 and the second surface is facing the grip cap 112.

In an example embodiment, the grip cavity 122 may be configured to receive a heating packet 200 therein. In an example embodiment, the heating packet 200 is a chemical heat packet. In an example embodiment, the heat packet 200 is sized to fit within the grip cavity 122. In an example embodiment, the heat packet 200 is a hand warmer packet and/or the like. In an example embodiment, the heat packet 200 contains chemicals that gives off heat when the chemicals are mixed together. In an example embodiment, the heat packet 200 contains chemicals that give off heat when exposed to oxygen. In an example embodiment, the heat packet 200 contains iron powder that reacts with oxygen in the air to produce iron oxide (rust) via an exothermic reaction. For example, the heat packet 200 may be activated by exposing the heat packet to the air and then the heat packet may be inserted into the grip cavity 122. In another example embodiment, the heat packet 200 can be reusable, such as a heat packet that uses a reversible reaction of sodium acetate salt crystals in water.

At least a portion of the heat (e.g., thermal energy) given off by the heat packet 200 is absorbed by the grip wall 124, for example, such that the grip wall 124 feels warm to the touch. The stopper 126 prevents the heat (e.g., thermal energy) given off by the heat packet 200 from being absorbed by and/or flowing down the shaft 150, at least in part. Thus, less of the heat given off by the heat packet 200 is wasted by heating the entire length of the shaft 150. Rather, instead of the heat flowing down the shaft 150, more of the heat is provided to the user's hands through the hand grip 110, thereby causing the hand grip 110 to feel warmer to the touch and making the golfing experience more enjoyable on a chilly day.

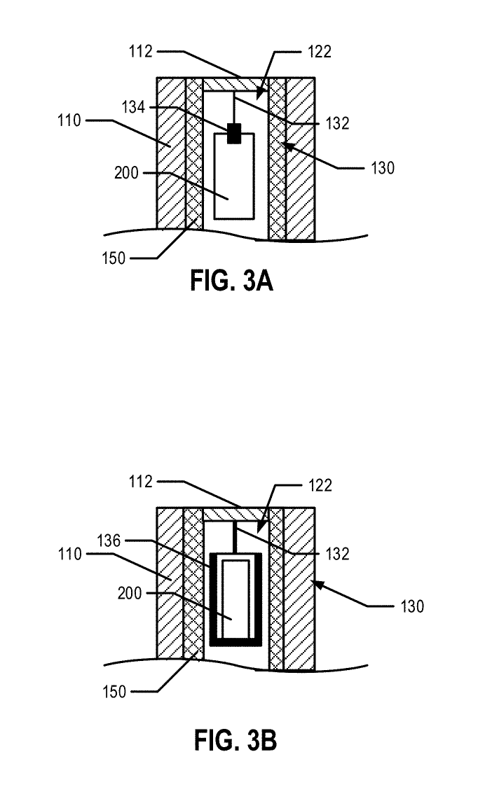

In an example embodiment, the heat packet 200 may be inserted into the grip cavity 122 such that the heat packet 200 rests on the stopper 126 and/or is wedged between opposite sides of the inner surface 120. In an example embodiment, the stopper 126 may be integrally formed with or otherwise connected to the heat packet 200 such that the stopper and heat packet can be inserted and removed from the golf club 100 together. In an example embodiment, the golf club 100 can further comprise a packet retaining assembly 130. FIGS. 3A and 3B show two examples of packet retaining assemblies 130. For example, a packet retaining assembly 130 may comprise a cord 132. A first cord end of the cord 132 may be secured to the grip cap 112. The cord 132 may further comprise a second cord end opposite the first cord end. The second cord end may have a packet retainer secured thereto. In an example embodiment, the cord 132 is rigid. In an example embodiment, the cord 132 is flexible. For example, the packet retainer may be configured to engage the heat packet 200. For example, the packet retainer may be a clip 134 configured to engage the heat packet 200 by clipping onto an edge or end of the heat packet. In another example, the packet retainer may be a pouch 136 configured to receive the heat packet 200 therein. In an example embodiment the pouch 136 is cup-shaped with the cup opening toward the grip cap 112. After the heat packet 200 is engaged by the packet retaining assembly 130 and inserted into the grip cavity 122, the heat packet may be suspended within the grip cavity by the packet retaining assembly.

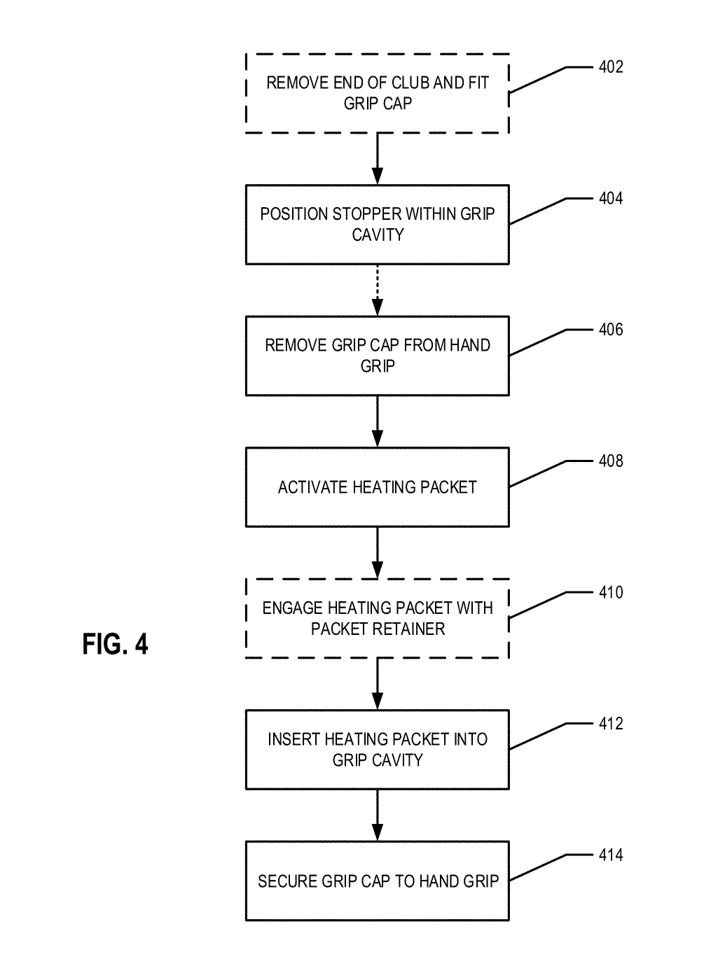

FIG. 4 provides a flowchart illustrating an example technique of preparing a golf club 100 with a heated hand grip 110 for use. Starting at block 402, the existing end of the golf club 100 is removed and a grip cap 112 is fitted thereto, in one example embodiment. For example, an opening may be made at the first end 116 of the hand grip 110 and/or shaft 150 such that access is provided to the interior of the shaft and/or the grip cavity 122. A selectively removable grip cap 112 may be fitted to the opening made in the first end 116 of the hand grip 110 and/or shaft 150. At block 404, a stopper 126 is disposed, wedged, and/or the like adjacent the second end 114 of the hand grip 110 and within the grip cavity 122. For example, the stopper 126 may be positioned within the grip cavity 122 and pushed through the grip cavity until the stopper 126 is generally adjacent the second end 114 of the hand grip 110. The golf club 100 may then be prepared for use with a heating packet 200. Immediately thereafter and/or at a later point in time, a heat packet 200 may be inserted into the grip cavity 122 of the golf club 100 to cause the golf club to have a heated hand grip 110. In an embodiment where the stopper 126 is integrally formed with or otherwise connected to the heat packet 200, the heat packet can be first activated and then the stopper and heat packet are inserted into the golf club 100 together.

In another embodiment, at block 406, the grip cap 112 is removed from the hand grip 110. For example, the user may remove the grip cap 112 from the first end 116. At block 408, the heating packet 200 is activated. For example, the heating packet 200 may be exposed to air so as to cause the heat providing chemical reaction to commence. At block 410, the heat packet 200 may optionally be engaged by a packet retainer of a packet retaining assembly 130. For example, the heat packet 200 may be inserted into a pouch 136, clipped by a clip 134, and/or the like. For example, a user may engage the heat packet 200 with a packet retainer or a packet retaining assembly 130. At block 412, the heat packet 200 is inserted into the grip cavity 122. For example, the user may insert the heat packet 200 into the grip cavity 122. At block 414, the grip cap 112 may be replaced. For example, the grip cap 112 may be secured to the first end 116 of the hand grip 110. The heat emitted by the heat packet 200 may then be absorbed by the shaft 150 in the portion thereof disposed between the first end 116 and the second end 114 such that when a user grips the hand grip 110, the hand grip feels warm to the touch. Moreover, the stopper prevents, at least in part, thermal energy and/or heat emitted by the heat packet from flowing down the shaft 150 such that a greater portion of the thermal energy and/or heat is provided to the hand grip 110, causing the hand grip to feel warmer when the user grips the hand grip. Once the user is finished using the golf club 100, the grip cap 112 may be removed from the first end 116 and the heat packet 200 may be removed from the grip cavity 122. The grip cap 112 may then be replaced and secured back onto the first end 116 of the hand grip 110.

In another embodiment, a heat packet can be formed in a relatively flat shape and be wrapped or wound around the shaft of an article of sporting equipment. The heat packet can be figured to fit under or over a grip for the shaft. The heat packet may be formed with a shape having a relatively thin portion to underlie the hand(s) of the user of the article of sporting equipment, and a relatively thicker portion at one or both ends of the relatively thin portion that does not underlie the hand(s) of the user. In an embodiment, the relatively thin portion comprises a foil made of a heat conductive material, such as metal, that is connected to the relatively thicker portion(s). In this way, heat generated by the relatively thicker portion(s) is conducted along the foil and under the hand(s) of the user. The foil is sufficiently thin that it does not noticeably affect the thickness of the grip felt by the user.

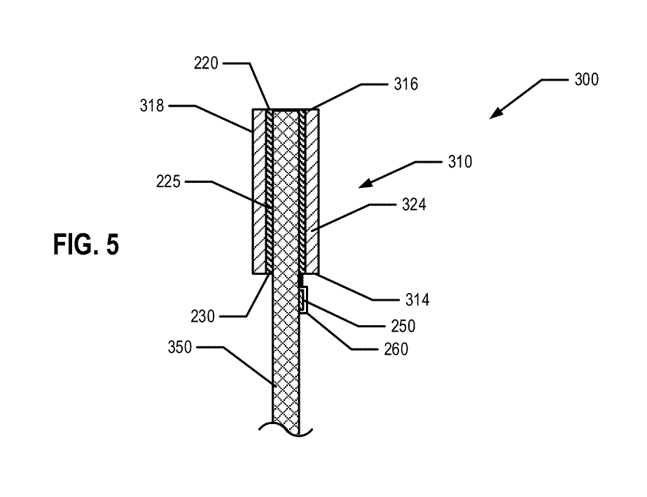

FIG. 5 illustrates an alternative embodiment wherein the example article of sporting equipment is a tennis racket 300 and the tennis racket 300 has a heated hand grip 310. For example, the tennis racket 300 may comprise a hand grip 310 disposed about a portion of the shaft 350. A first end 316 of the hand grip 310 is disposed at a first end of the shaft 350 such that the first end 316 is the first end of both the hand grip 310 and the shaft 350. The hand grip 310 extends along the shaft 350 from the first end 316 to a second end 314 of the hand grip 310 at an intermediate point of the shaft 350.

In an example embodiment, the tennis racket 300 may have a heated grip tape and/or sleeve 220 disposed around the grip 310. In an example embodiment, the heated grip tape and/or sleeve 220 is a flexible material and/or substrate 230 having a flexible electrical circuit 225 secured thereto. In an example embodiment, the flexible material 230 is a thin material. For example, the flexible material 230 may have a thickness similar to that of paper. For example, the flexible material 230 may be thin enough such that the addition of the heated grip tape and/or sleeve 220 increases the diameter of the grip 310 of the tennis racket by less than half an inch, less than a quarter of an inch, less than an eighth of an inch, less than a sixteenth of an inch, and/or the like in various embodiments. For example, the heated grip tape and/or sleeve 220 may have a thickness in the range of approximately 0.025 to 0.5 mm.

In an example embodiment, the heated grip tape and/or sleeve 220 may be a flexible material 230 that is printed with a flexible electrical circuit 225 configured for providing heat output. For example, the heated grip tape and/or sleeve 220 may comprise one or more flexible heating elements printed thereon. For example, the flexible electrical circuit 225 may comprise one or more flexible heating elements. The flexible heating elements may be in electrical communication with a highly conductive electric bus configured to deliver uniform power (e.g., from a power source 250) to individualized point resistive heaters or to a uniform resistive heating layer. The electric bus may be incorporated into (e.g., printed on) the heated grip tape and/or sleeve 220, in an example embodiment. The resistive materials are configured to be stable across temperature regions. In an example embodiment, the heating elements comprise positive-temperature-coefficient resistors. The heating elements used and the configuration/layout thereof on the heated grip tape and/or sleeve 220 are configured to operate in a steady state and/or self-limiting mode to achieve a desired temperature (e.g., a temperature in the range of 75-80° F., or 70-85° F. in example embodiments). For example, positive-temperature-coefficient resistors can self-regulate operational temperature due to resistance change with temperature. Due to the positive-temperature-coefficient of the resistors, the current draw of the heating elements of the heated grip tape and/or sleeve 220 decreases as the heater warms and will eventually reduce such that the heater will no longer maintain temperature. As the heating elements of the heated grip tape and/or sleeve 220 cool, the current will rise again causing the heater to maintain an operational temperature. For example, the heated grip tape and/or sleeve 220 may comprise printed flexible heaters and/or warming elements such as those produced by GSI Technologies.

A power source 250 may be secured to and/or within the tennis racket 300. For example, a power source receiver 260 may be secured to and/or built into the shaft 350 of the tennis racket 300 proximate the second end 314 of the grip 350 as shown, or proximate the first end such as being located on the butt end of the tennis racket. In an example embodiment, a power source receiver 260 comprises a compartment configured for securing a power source 250 therein such that the power source 250 is and/or may be selectively placed into electrical communication with the flexible electrical circuit 225. In an example embodiment, when the power source 250 is secured within the power source receiver 260, the power source 250 is operatively connected to the heated grip tape and/or sleeve 220. For example, the power source receiver 260 may comprise electrical wires for providing an electrical connection between the flexible electrical circuit 225 of the heated grip tape and/or sleeve 220 and the power source 250. In an example embodiment, the power source receiver 260, may comprise a power element such as a button, switch, and/or the like for us in activating and/or deactivating the heating of the heated grip tape and/or sleeve 220. For example, the power element may be configured to selectively cause the power source 250 to provide electrical power, current, and/or voltage to the flexible electrical circuit 225 to cause the heating thereof. In an example embodiment, the power source receiver 260 may also have secured thereto and/or disposed therein, controlling circuitry configured to control the flow of electrical power from the power source 250 to the flexible electrical circuit 225 of the heated grip tape and/or sleeve 220 such that the temperature heat output of the heated grip tape and/or sleeve is approximately 75-80° F. In an example embodiment, the power source receiver 260 and/or power element may comprise a temperature selector (e.g., a dial, multi-position switch, and/or the like) that is in communication with the controlling circuitry such that a user may select a desired temperature heat output of the heated grip tape and/or sleeve 220. In various embodiments, the power source 250 may be a battery and/or a plurality of batteries. For example, the power source 250 may comprise one or more button cell batteries, watch batteries, and/or the like. In an example embodiment, wherein the article of sporting equipment is a golf club or other article of sporting equipment having a hollow shaft, the grip cap 112 may comprise a power source receiver 260 for securing the power source 250 thereto, within the golf club, and/or the like.

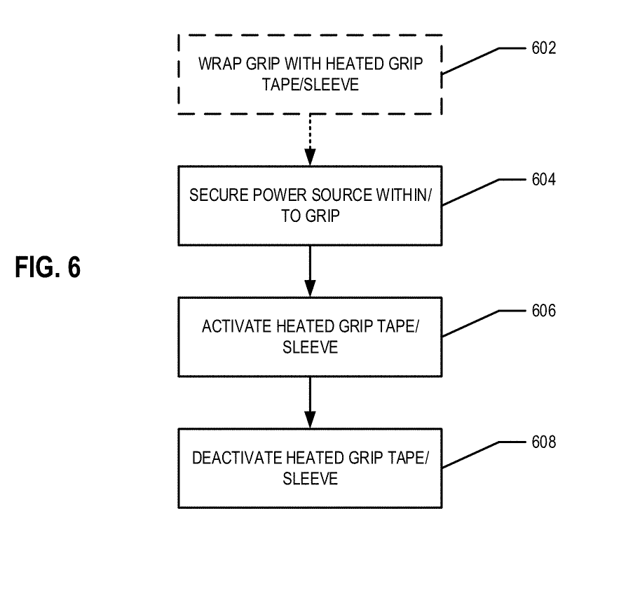

FIG. 6 provides a flowchart illustrating an example technique for preparing and using a tennis racket 300 having a heated hand grip 310. For example, at block 602, the heated grip tape and/or sleeve 220 around the grip 310 portion of the shaft 350. For example, a user may purchase, provide, receive, and/or the like a heated grip tape and/or sleeve 220 configured to be wrapped around the grip portion 310 of the shaft 350 of a tennis racket and/or other article of sporting equipment. The heated grip tape and/or sleeve 220 may comprise a flexible electrical circuit 225 comprising one or more resistive heating elements disposed on (e.g., printed on) a flexible material 230, wherein the flexible material 230 comprises one of a thin, flexible tape or a sleeve configured to secure the flexible electrical circuit 225 to the hand grip 310 portion of a shaft 350 of an article of sporting equipment. The heated grip tape and/or sleeve 220 further comprises a power source receiver 260 in electrical communication with the flexible electrical circuit 225, in an example embodiment. The heated grip tape and/or sleeve 220 may be wrapped about the grip 310 portion of a shaft 350 of the tennis racket 300 and the power source receiver 260 may be secured to the shaft proximate the second end 314 of the grip 310 (and/or within the shaft).

For example, a user may wrap the grip 310 with the heated grip tape 220. For example, the heated grip tape 220 may be a single-sided tape having adhesive on one side for use in securing the heated grip tape 220 to the surface of the grip 310 portion of the shaft 350. The heated grip tape 220 may have a cross-tape width in the range of one-quarter of an inch to the length of the grip 310 (e.g., the distance between the first end 316 and the second end 314). In general, the heated grip tape 220 is thin. For example, the heated grip tape 220 may have a thickness comparable to a piece of paper.

In another example embodiment, a user may pull a heated grip sleeve 220 over the grip 310 portion of the shaft 350. For example, the heated grip sleeve 220 may be a hollow, flexible cylindrical sleeve configured to be pulled over the grip 110. The heated grip sleeve 220 may have some elasticity and/or capacity for being stretched such that the user may pull and/or maneuver the heated grip sleeve 220 over the grip 310 portion of the shaft 350 and the size of the hollow portion of the cylindrical sleeve when not being actively stretched is configured to hold the heated grip sleeve 220 on the shaft 350. In an example embodiment, the heated grip tape and/or sleeve 220 may be secured, attached, installed, wrapped, and/or pulled onto the grip 310 portion of the shaft 350 during the manufacturing of the tennis racket 300 rather than by the user.

Once the heated grip tape and/or sleeve 250 is wrapped and/or secured about the grip 310 portion of the shaft 350, an overgrip 324 may be wrapped and/or secured over the heated grip tape and/or sleeve 250. For example, a user and/or manufacturing element may wrap the grip 310 of the tennis racket 300 with an overgrip 324. For example, the overgrip 324 may be traditional grip tape, such as, for example, a felt and/or cushioning overgrip tape. In an example embodiment, the heated grip tape and/or sleeve 220 is wrapped over the overgrip 324 rather than underneath the overgrip 324.

At block 604, a power source 250 is secured within and/or to the grip 110 and/or the shaft 150. For example, the user may position and/or secure the power source 250 in a power source receiver 260 secured to and/or built into the shaft 350, in an example embodiment. In another example, the user may position and/or secure the power source 250 into a power source receiver 260 positioned along the shaft 350 proximate the second end 314 of the grip 310.

At block 606, the heated grip tape and/or sleeve 220 may be activated. For example, a user may use and/or interact with a power element such as a power button, switch, and/or the like to activate the supply of electrical power from the power source 250 to the heated grip tape and/or sleeve 220 (e.g., to the flexible electrical circuit 225) to activate the heating of the heated grip tape and/or sleeve 220 (e.g., via electrical activation of the one or more resistive heating elements). In an example embodiment, a user may secure one or more electrical leads to the terminals of the power source 250 to activate the supply of electrical power from the power source 250 to the heated grip tape and/or sleeve 220 to activate the heating of the heated grip tape and/or sleeve 220. For example, securing the power source 250 within the power source receiver 260 may activate the supply of electrical power from the power source 250 to the heated grip tape and/or sleeve 220 to activate the heating of the heated grip tape and/or sleeve 220.

After activating the heating of the heated grip tape and/or sleeve 220, the user may then use the tennis racket 300 to play a match, and/or engage in other sporting activities. Once the user is finished using the tennis racket or the day or user has warmed sufficiently that the user no longer desires the grip 310 of the tennis racket 300 to be actively heated, the user may deactivate the supply of electrical power from the power source 250 to the heated grip tape and/or sleeve 220 to cease the heating of the heated grip tape and/or sleeve 220 at block 608. For example, a user may use and/or interact with the power element (e.g., button, switch, and/or the like) to deactivate the supply of electrical power from the power source 250 to the heated grip tape and/or sleeve 220 (e.g., to the flexible electrical circuit 225) to cease the heating of the heated grip tape and/or sleeve 220. In an example embodiment, a user may take one or more electrical leads out of contact with the terminals of the power source 250 to deactivate the supply of electrical power from the power source 250 to the heated grip tape and/or sleeve 220 to cease the heating of the heated grip tape and/or sleeve 220. For example, removing the power source 250 from the power source receiver 260 may deactivate the supply of electrical power from the power source 250 to the heated grip tape and/or sleeve 220 to cease the heating of the heated grip tape and/or sleeve 220.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. An article of sporting equipment having a heated hand grip, the article of sporting equipment comprising:
a shaft, wherein (a) the shaft is at least partially hollow, (b) the interior of the shaft defines in part a grip cavity, and (c) a grip cap is disposed at a first end of the shaft to define one end of the grip cavity;
a hand grip disposed about a portion of the shaft, wherein (a) a first end of the hand grip is disposed at a first end of the shaft and (b) the hand grip extends along the shaft from the first end to a second end of the hand grip at an intermediate point of the shaft; and
a stopper disposed adjacent the second end of the hand grip and defining an opposite end of the grip cavity,
wherein the stopper is made of a thermally insulating material configured to insulate against thermal energy generated by a chemical heating packet inserted within the grip cavity from flowing down the shaft away from the grip cavity.

2. The article of sporting equipment of claim 1, wherein the shaft is made of a thermally conductive material.

3. The article of sporting equipment of claim 1, wherein the stopper is made of sponge, expandable polyurethane, or rubber.

4. The article of sporting equipment of claim 1, wherein the grip cap is selectively removable from the shaft.

5. The article of sporting equipment of claim 1 further comprising a packet retaining assembly.

6. The article of sporting equipment of claim 5, wherein the packet retaining assembly comprises a cord, the cord having a first cord end secured to the grip cap such that, when the grip cap is disposed on the first end of the shaft, a second cord end opposite the first cord end extends into the grip cavity.

7. The article of sporting equipment of claim 6, wherein a packet retainer is secured to the second cord end, wherein the packet retainer is configured to selectively removably secure a chemical heating packet to the cord.

8. An article of sporting equipment having a heated hand grip, the article of sporting equipment comprising:
a shaft;
heated grip tape about at least a portion of a grip portion of the shaft, wherein (a) a first end of the grip portion of the shaft is disposed at a first end of the shaft and (b) the grip portion of the shaft extends along the shaft from the first end to a second end of the grip portion of the shaft at an intermediate point of the shaft;
an overgrip disposed about the heated grip tape and the grip portion of the shaft;
and
a power source receiver configured to receive a power source therein and place the power source in electrical communication with the heated grip tape.

9. The article of sporting equipment of claim 8, wherein the power receiver is secured to the shaft proximate the second end of the grip portion.

10. The article of sporting equipment of claim 8, wherein (a) the shaft is at least partially hollow, (b) the interior of the shaft defines a grip cavity, (c) a grip cap is disposed at a first end of the shaft to enclose the grip cavity, and (d) the power source receiver is configured to be disposed within the grip cavity when the article of sporting equipment is in use.

11. The article of sporting equipment of claim 10 wherein the grip cap comprises the power source receiver.

12. The article of sporting equipment of claim 8, wherein the power source receiver is in communication with a power element configured to selectively activate or deactivate the supply of electrical power to the heated grip tape based on user interaction with the power element.

13. The article of sporting equipment of claim 8, wherein the power source receiver is in electrical communication with controlling circuitry configured to control the supply of electrical power to the heated grip tape.

14. The article of sporting equipment of claim 8, wherein the heated grip tape comprises a flexible printed material comprising one or more resistive heating elements.

15. The article of sporting equipment of claim 14, wherein the one or more resistive heating elements comprise at least one positive-temperature-coefficient resistors.

16. The article of sporting equipment of claim 8, wherein the heated grip tape is a single-sided tape comprising an adhesive on one side thereof.

17. A heated hand grip for an article of sporting equipment, the heated hand grip comprising:
a flexible electrical circuit comprising one or more resistive heating elements disposed on a flexible material, wherein the flexible material comprises a tape configured to secure the flexible electrical circuit to the grip of a shaft an article of sporting equipment; and
a power source receiver in electrical communication with the flexible electrical circuit.

18. The heated hand grip of claim 17, wherein the flexible electrical circuit is printed onto the flexible material.

19. The heated hand grip of claim 17, wherein the power source receiver is in communication with a power element configured to selectively activate or deactivate the supply of electrical power to the flexible electrical circuit based on user interaction with the power element.

20. The heated hand grip of claim 17, wherein the power source receiver is in electrical communication with controlling circuitry configured to control the supply of electrical power to the flexible electrical circuit.

21. The heated hand grip of claim 17, wherein the one or more resistive heating elements comprise at least one positive-temperature-coefficient resistors.

22. The heated hand grip of claim 17, wherein the tape is a single-sided tape comprising an adhesive on one side thereof.

23. The heated hand grip of claim 17, wherein a thickness of the flexible material is in the range of 0.025 to 0.5 mm.
